(19) United States
(12) Patent Application Publication
(10) Pub. No.: US 2003/0044056 A1
(43) Pub. Date: Mar. 6, 2003

(54) Post-seal inspection system

(75) Inventors: Dallin Katt, Waukesha, WI (US); Mark R. Shires, Glendale, WI (US); Robert G. Bertz, Wauwatosa, WI (US); Michael Reilly, New Berlin, WI (US); Merlin Behnke, Grafton, WI (US)

Correspondence Address: MICHAEL BEST & FRIEDRICH, LLP, 100 E WISCONSIN AVENUE, MILWAUKEE, WI, 53202, US

(73) Assignee: Robotic Vision Systems, Inc., Canton, MA

(21) Appl. No.: 10/171,466

(22) Filed: Jun. 13, 2002

Related U.S. Application Data
(60) Provisional application No. 60/297,853, filed on Jun. 13, 2001.

(51) Int. Cl. G06K 9/00

(52) U.S. Cl. 382/143

(57) ABSTRACT

A method for inspecting composite tape including cover tape bonded to carrier tape comprises capturing a digital image of the composite tape, dividing the seal tracks within the image into a plurality of fragments or segments. The method also provides for analyzing each segment of the seal track for the presence or absence of the seal and for the width of the seal, and assigning a failing grade to the segment if the seal is not continuous within the segment or if the seal has a width less than a minimum width within the segment. The method further provides for notifying a machine operator of a defective seal if the number consecutively-failed segments in the seal track exceeds a defect tolerance. The method also provides for measuring the spacings of the carrier tape edge, cover tape edge, and seal tracks from each other and comparing those spacings to acceptable values.

This application claims the benefit of U.S. Provisional Patent Application No. 60/297,853, filed Jun 13, 2001.

### BACKGROUND

The invention relates to an electronic part inspection and packaging apparatus, and more specifically to a system for inspecting the seal between the cover tape and carrier tape used to package the electronic parts.

### SUMMARY

The invention provides a method and apparatus for capturing a digital image of a seal track for a carrier tape and cover tape assembly, and for analyzing the seal track for defects. The invention use gradient-based edge tools to find the edges of the carrier tape, cover tape, and seal tracks, and calculates robust line equations for the edges. The invention also divides the seal tracks into segments and inspects each segment to determine whether the seal is continuous within the segment and whether the width of the seal is greater than a minimum width. If the seal is not continuous, is too narrow, or is too wide within the segment, the segment is labeled as failing. The invention then assesses whether the entire seal is acceptable based on the number of consecutive failing segments in the seal.

Other features and advantages of the invention will become apparent to those skilled in the art upon review of the following detailed description, claims, and drawings.

### BRIEF DESCRIPTION OF THE DRAWINGS

FIG. 1 is a side view of an electronic part inspection and packaging machine embodying the present invention.

FIG. 2 is a top view of the machine.

FIG. 3 is a perspective view of a length of carrier tape for use with the invention.

FIG. 4 is a top view of composite tape containing electronic parts as the composite tape passes under the camera after seal inspection (“CASI”) module.

FIG. 5 is a cross-section view taken along line 5-5 in FIG. 4.

FIG. 6 is a top view of an example image captured by the CASI module.

FIG. 7 is an example image of a portion of a seal track being analyzed by the CASI module.

FIG. 8, consisting of FIGS. 8A-8C, is a flow chart of the CASI software logic.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION

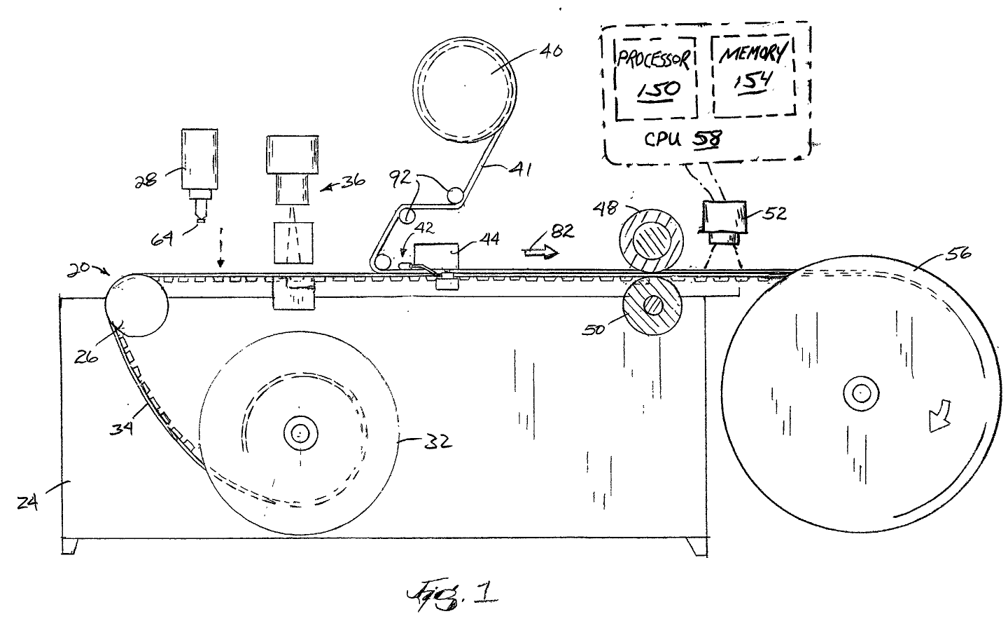

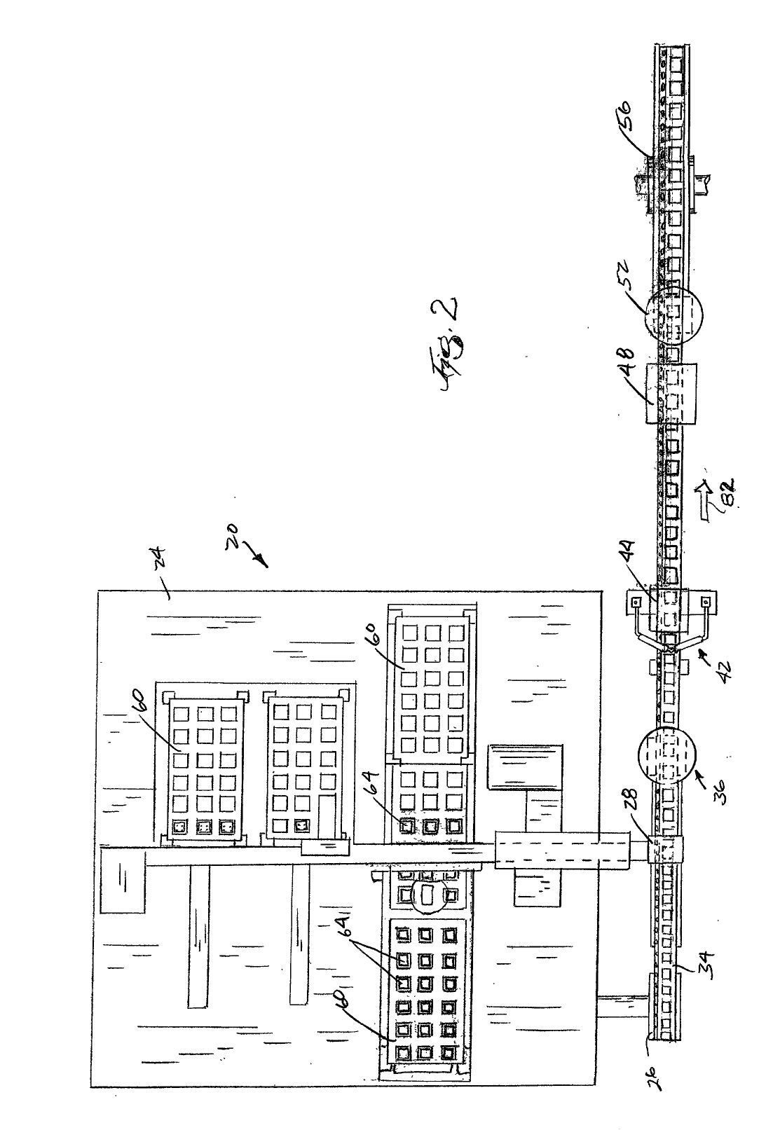

FIGS. 1 and 2 illustrate an inspection, handling, and packaging apparatus 20 that includes a support stand 24, an infeed carrier tape drive wheel 26, a pick-and-place head or transport 28, a carrier tape infeed reel 32 dispensing carrier tape 34, a camera-over-tape or “COT” inspection module 36, a cover tape reel 40 dispensing cover tape 41, a cover tape flattening, smoothing, or combing mechanism 42, a sealing shoe 44, a resilient drive roller 48, a backup wheel 50, a camera-after-sealing inspection module or “CASI” module 52, and an output reel packaging module 56. A controller or CPU 58 (illustrated schematically) controls all aspects of the apparatus 20, and executes the software associated with the CASI module 52. The support stand 24 supports a plurality of part input trays 60 that contain parts 64 to be inspected and packaged. The transport 28 picks the parts 64 off the input trays 60, and transfers the parts 64 to the carrier tape 34. The transport 28 is preferably a pick-and-place type transport utilizing a vacuum head.

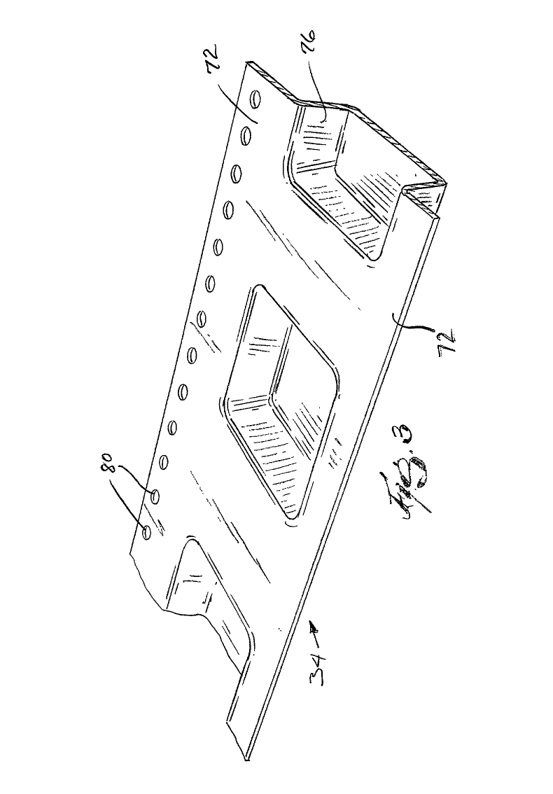

The carrier tape 34 is best illustrated in FIG. 3, and includes a pair of flanges 72 running along its length, and compartments 76 formed between the flanges 72. One or both of the flanges 72 may include sprocket holes 80 to facilitate advancing the carrier tape 34 through the apparatus 20 and/or other machinery. For example, the infeed carrier tape drive wheel 26 may be a pinwheel having sprocket pins that engage the sprocket holes 80 of the carrier tape 34. The drive wheel 26 may be driven under power by a motor (not illustrated) to pull the carrier tape 34 off the infeed reel 32. Alternatively, the drive wheel 26 may have a smooth or flat surface and/or be passive or not driven by a motor.

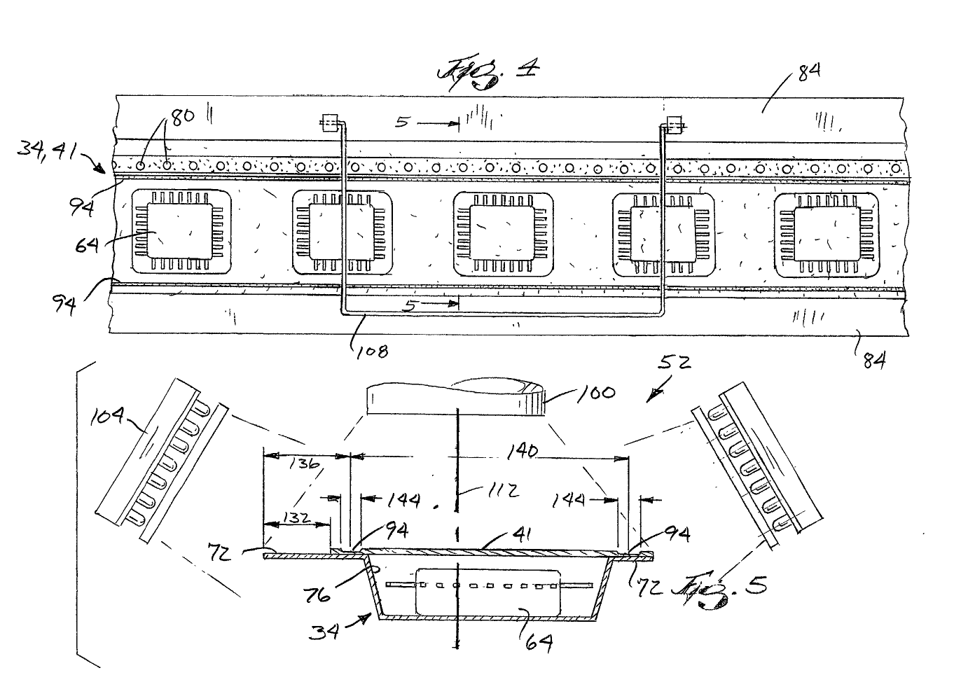

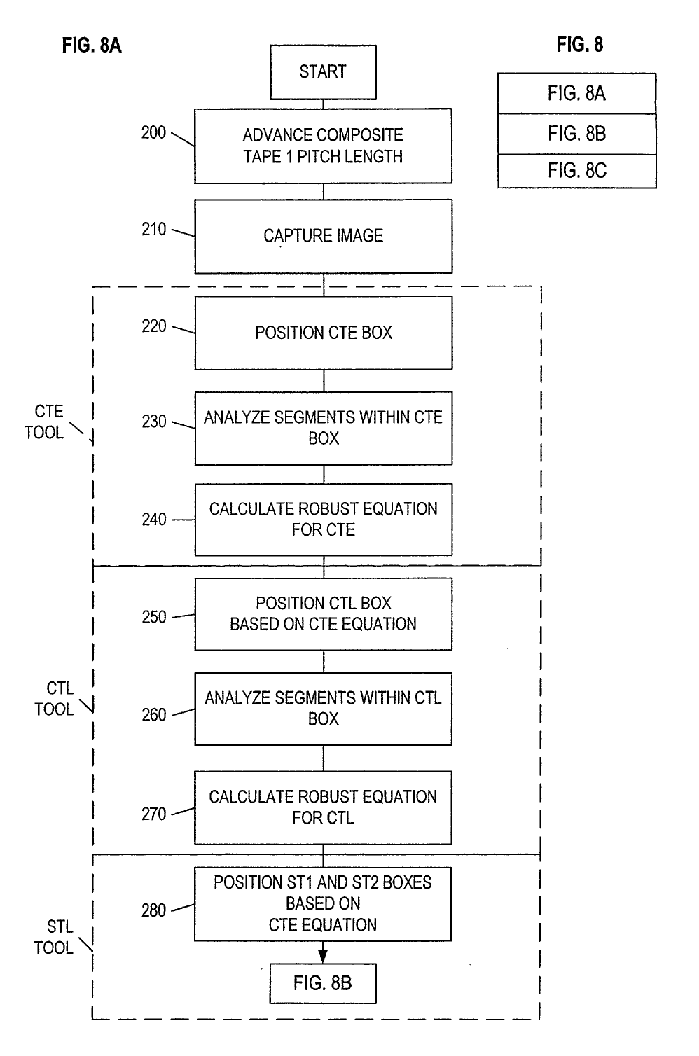

The resilient drive roller 48 rotates under the power of a motor (not illustrated) to pull the carrier tape 34 through the apparatus 20 in a downstream direction 82 (an upstream direction being opposite the downstream direction 82). The flanges 72 of the carrier tape 34 are pinched between the drive roller 48 and the backup wheel 50 to facilitate the advancement of the carrier tape 34 under the influence of the rotating drive roller 48. Alternatively, the drive roller 48 may include pins that engage the sprocket holes 80 in the tape flanges 72 to facilitate advancing the carrier tape 34 through the apparatus 20. The carrier tape 34 is supported at its flanges 72 by guide rails 84 (FIGS. 4 and 6) that extend substantially the entire length of the apparatus 20. The rails 84 are preferably made of nickel or some other light-reflective material.

Referring again to FIGS. 1 and 2, the transport 28 places a single part 64 into each compartment 76 of the carrier tape 34. The COT inspection module 36 is downstream of the transport 28, and includes a camera, which inspects the parts 64 in the carrier tape compartments 76 as the carrier tape 34 is advanced through the apparatus 20.

The cover tape 41 is laid on top of the carrier tape 34 downstream of the COT inspection module 36, and is pulled through the apparatus 20 along with the carrier tape 34. The cover tape 41 is guided from the cover tape reel 40 to the carrier tape 34 by a plurality of tensioning rollers 92. The cover tape 41 extends between the flanges 72 and completely covers the compartments 76. The smoothing mechanism 42 smoothes wrinkles out of the cover tape 41 just before the cover tape 41 and carrier tape pass under the sealing shoe 44. The smoothing mechanism 42 and sealing shoe 44 may be collectively referred to as a cover tape application module.

Adhesive is used to seal the cover tape 41 to the flanges 72 of the carrier tape 34 and thereby create a composite tape including the carrier/cover tape combination. The adhesive is on the cover tape 41 surface and faces the carrier tape 34, or may alternatively be provided on the carrier tape 34 flanges 72 and face the cover tape 41. The adhesive is preferably heat activated or pressure sensitive adhesive. Heat activated cover tape 41 has adhesive across the complete cover tape surface. Pressure sensitive activated cover tape 41 has only two strips of adhesive that are located over the flanges 72 of the carrier tape 34. The adhesive is activated by pressure and/or heat applied through the sealing shoe 44.

FIG. 4 illustrates the carrier tape 34 with the cover tape 41 adhered thereto as viewed by the CASI module 52. The adhesive bonds the cover tape 41 to the carrier tape flanges 72 along two generally parallel and continuous lines or strips 94, which are also referred to as seal tracks herein. The CASI module 52 inspects the quality of the seal created by the adhesive and identifies potentially flawed segments of the adhesive seal, as will be described in more detail below.

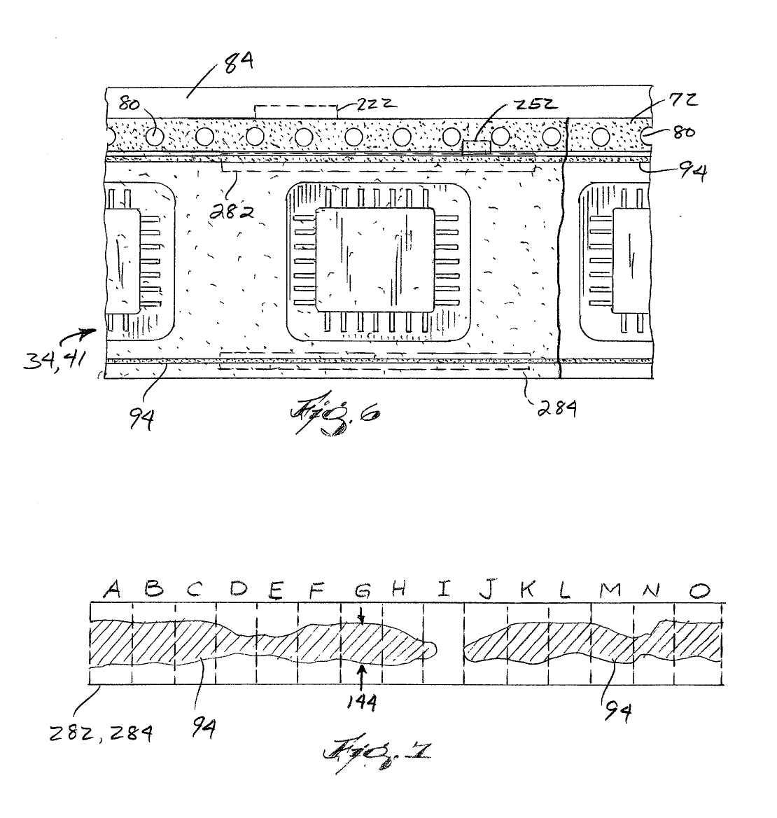

The following is a description of some of the system requirements in the preferred commercial embodiment of the invention. Once the preferred system requirements are discussed, the operation of the CASI module 52 will be discussed. The CASI module 52 is currently commercially available on the following machines sold by RVSI Systemation: ST60, ST585, ST595, and CST-90. The CASI module 52 uses a fixed or zoom lens camera 100 (FIG. 5) to optimize the field-of-view (“FOV”). The FOV is optimized when the inspection area for the CASI module 52 is unobstructed for just over one full composite tape pitch, so that there is some overlap between adjacent lengths of composite tape as it advances incrementally one pitch-length at a time under the CASI module 52. In the preferred commercial embodiment, the overlap is set to 50% of the pitch on either side of the length of composite tape being inspected, but more or less overlap may be used.

The seal track 94 edges should be sufficiently isolated and thick to facilitate inspection by the CASI module 52. In the preferred embodiment, the outer seal track 94 edges are considered isolated when they are the greater of two pixel rows or 0.005″ (0.127 mm) away from the edge of the cover tape 41. The seal track widths are considered thick in the preferred embodiment when they are the greater of two pixel rows or 0.010″ (0.254 mm) wide.

A cloudy-day illuminator (“CDI”) 104 (FIG. 5) provides cloudy-day illumination within the CASI module 52. A preferred and commercially-available CDI is RVSI Northeast Robotics model no. NER SCDI-75. The height from the bottom of the CDI 104 to the carrier tape 41 is preferably no greater than 0.3″ (7.6 mm).

The CASI module 52 works best when the cover tape 41 is laid flat over the carrier tape 34, which is why it is preferred to have the cover tape smoother 42 up stream of the heat sealer 44. If the cover tape 41 is not smoothly applied to the carrier tape 34, the CDI 104 lighting may be affected, and this may result in the CASI module 52 identifying false seal defects and flagging a false rejection. A wire frame 108 (FIG. 4) around the FOV may be employed to lightly tension the cover tape 41 and further reduce such false rejections.

To further reduce false rejections, a contrast should be maintained between the seal track 94 edges and the areas on either side of the seal track 94, so that the seal track 94 edges are clearly visible. This may be accomplished by using carrier tape 34 having a light-absorptive color (e.g., black in the preferred embodiment), and cover tape 41 that is light-diffusive (e.g., semi-transparent cover tape in the preferred embodiment). The CDI 104 lighting is largely absorbed by the carrier tape 34, and is diffused by the cover tape 41 such that the cover tape 41 appears to be a light color against the dark-color background of the carrier tape flanges 72 when viewed with the CASI module camera 100. When the cover tape 41 is bonded to the carrier tape 34, the cover tape 41 becomes substantially transparent to light in the seal tracks 94, and the seal tracks 94 appear as dark lines in the light-colored cover tape 41 because the dark carrier tape 34 material shows through.

To further reduce false rejections, the plane of the camera lens should be maintained substantially parallel (e.g., within 1° of parallel in the preferred embodiment) to the longitudinal extent of both seal track 94 edges. Stated another way, the cover tape 41 defines a plane of inspection for the CASI module 52, and the optical axis 112 (FIG. 5) of the camera 100 should be maintained substantially perpendicular to the plane of inspection.

One goal of the CASI module 52, as will be explained below, is to determine various parameters of the composite tape. With reference to FIG. 5, these parameters include: the distance 132 from the carrier tape edge to the cover tape edge; the distance 136 from the carrier tape edge to the first seal track 94; the distance 140 between the centers of the seal tracks 94; and the width 144 of each seal 94.

The CASI module 52 includes several different software modules or tools that are executable by the CPU 58. As schematically shown in FIG. 1, the CPU 58 includes a processor 150 and a memory 154. The memory 154 stores the software modules, and the processor 150 retrieves, interprets, and executes the software modules to perform the operations of the CASI module 52. For the embodiment described herein, the CPU 58 is a Pentium PC. However, other CPUs or controllers (e.g., programmable controllers) can be used. Additionally, as should be apparent to those of ordinary skill in the art, some software may be implemented in hardware using mechanisms such as hardware descriptor language (“HDL”) to create application specific or special purpose circuits. Accordingly, elements described herein should not necessarily or inevitably be limited to a software or hardware embodiment simply because examples given are set forth in hardware or software specific terms. The terms CPU and controller are used interchangeably herein and, unless specifically limited, encompass CPUs, controllers, application specific or special purpose circuits, and similar devices.

While only a processor 150 and memory 154 are shown, the CPU 58 can include other devices or other circuitry (e.g., drivers, A/D converters, conditioners, etc.). Further, the CPU 58 can be connected to other CPUs via a network and the software modules stored and executed by the CPU 58 are not limited to the modules described below. The apparatus 20 also includes input and output devices that provide an interface between the CPU and an operator. Example input devices include, but not limited to, a keyboard, a keypad, a pointing device, and a touch screen. Example output devices include, but not limited to, a display, a printer, a magnetic storage device, and an optical storage device.

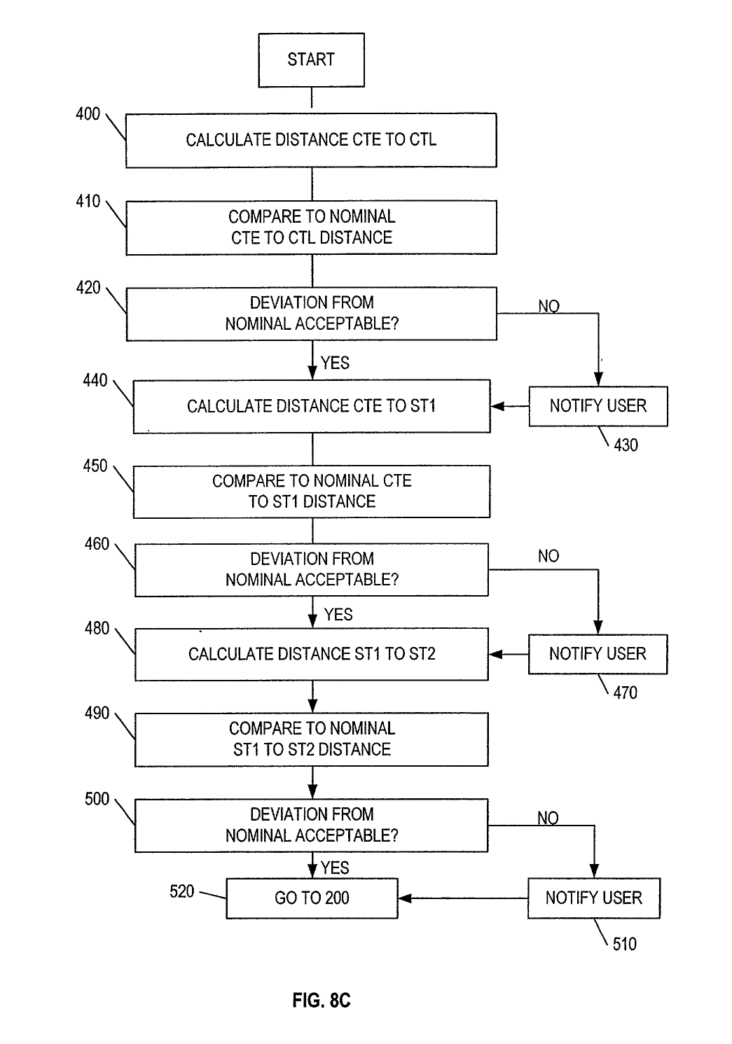

These include: a carrier tape edge (CTE) tool; a cover tape location (CTL) tool; and a seal track location (STL) tool. The operation of these software modules will be discussed with reference to FIG. 8 primarily, and also with reference to FIGS. 5 and 6.

As seen in FIG. 8A, at 200 the machine advances the composite tape one pitch length. At 210 the CASI module camera 100 captures a digital image (FIG. 6) of the length of composite tape within the FOV.

The CTE tool includes boxes 220-240 in FIG. 8A. At 220, the CTE tool positions a CTE box 222 (FIG. 6) around a portion of the carrier tape 34 edge (abbreviated “CTE”). The CTE box 222 defines a search region for the CTE tool. The length of the CTE box 222 preferably spans at least two sprocket holes 80.

At 230, the CTE tool analyzes segments within the CTE box 222. This includes dividing the CTE box 222 into a selected number of segments or sample regions, and using the CTE box 222 as a gradient-based edge tool. The CTE tool is programmable, and a machine operator may input the number of segments into which the CTE box 222 is divided in order to select the number of samples desired. The CTE box 222 is preferably fixed where the edge of the carrier tape 34 is predicted to be within the digital image (i.e., the nominal position of the CTE). The CTE box 222 is wide enough to accommodate normal variations in the position of the CTE. The nickel rail 84 provides a silver background for the edge of the carrier tape 34, and therefore creates a large contrast to assist the CTE tool identify the CTE.

The CTE tool analyzes each segment within the CTE box 222 to find a light-to-dark edge transition corresponding to the edge of the carrier tape 34 with the nickel rail 84 behind it. The allowable range for the grayscale threshold level to detect the upper edge of the carrier tape 34 is 0 to 255, with the default setting preferably being 40. At 240, the CTE tool calculates a robust equation for the carrier tape edge CTE. This calculation includes uses the edge data from each segment within the CTE box 222 to construct the robust line equation. The CTE equation is used as a datum by the CTL and STL tools, as will be described below.

The CTL tool includes steps 250-270 in FIG. 8A. At 250, the CTL tool positions a CTL box 252 (FIG. 6) within the digital image. The CTL box 252 is located a fixed distance from the CTE datum, around the nominal position of the cover tape edge or location (abbreviated “CTL”), and defines the search region for the CTL tool. The upper edge of the CTL box 252 is aligned with the a sprocket hole 80 and lower edge of the box 252 is over the cover tape 41 near the upper edge of the carrier tape compartment 76.

At 260, the CTL tool analyzes segments within the CTL box 252. This includes dividing the CTL box 252 into a selected number of segments or sample regions, and using the CTL box 252 as a gradient-based edge tool. The CTL tool is programmable, and a machine operator may input the number of segments into which the CTL box 252 is divided in order to select the number of samples desired. The CTL box 252 is preferably fixed where the edge of the cover tape 41 is predicted to be within the digital image (i.e., the nominal position of the CTL), based on the position of the CTE as calculated by the CTE tool. The CTL box 252 is wide enough to accommodate normal variations in the position of the CTL. The carrier tape 34 provides a black background for the edge of the cover tape 41, and therefore creates a large contrast to assist the CTL tool identify the cover tape edge.

The CTL tool analyzes each segment within the CTL box 252 to find a dark-to-light edge transition corresponding to the edge of the cover tape 41 with the carrier tape 34 behind it. The allowable range for the grayscale threshold level to detect the upper edge of the cover tape 41 is 0 to 255, with the default setting preferably being 40. At 270, the CTL tool calculates a robust equation for the CTL by using the edge data from each segment within the CTL box 252.

The STL tool includes steps 280-390 in FIGS. 8A and 8B. At 280, the STL tool positions ST1 and ST2 boxes 282, 284 (FIG. 6) within the digital image. The STL boxes 282, 284 are located a fixed distance from the CTE datum, around the nominal positions of the first and second seal tracks (abbreviated “ST1” and “ST2”), and define the search regions for the STL tool. The length of the STL boxes 282, 284 is about equal to the pitch length of the composite tape, and is preferably slightly longer than the pitch length so there is some overlap at both ends of the STL boxes 282, 284 with the previous and next pitch lengths inspected by the CASI module 52.

At 290, the STL tool analyzes segments within the STL boxes 282, 284. This includes dividing the STL boxes 282, 284 into a selected number of segments or sample regions, and using the STL boxes 282, 284 as gradient-based edge tools. The STL tool is programmable, and a machine operator may input the number of segments into which the STL boxes 282, 284 are divided in order to select the number of samples desired. The STL boxes 282, 284 are preferably fixed where the STI and ST2 94 are predicted to be within the digital image (i.e., the nominal position of the seal tracks), based on the position of the CTE as calculated by the CTE tool. The STL boxes 282, 284 are wide enough to accommodate normal variations in the position of the seal tracks 94. The cover tape 41 provides a light-colored background for the edges of the seal tracks 94, and therefore creates a large contrast to assist the STL tool identify the seal track edges.

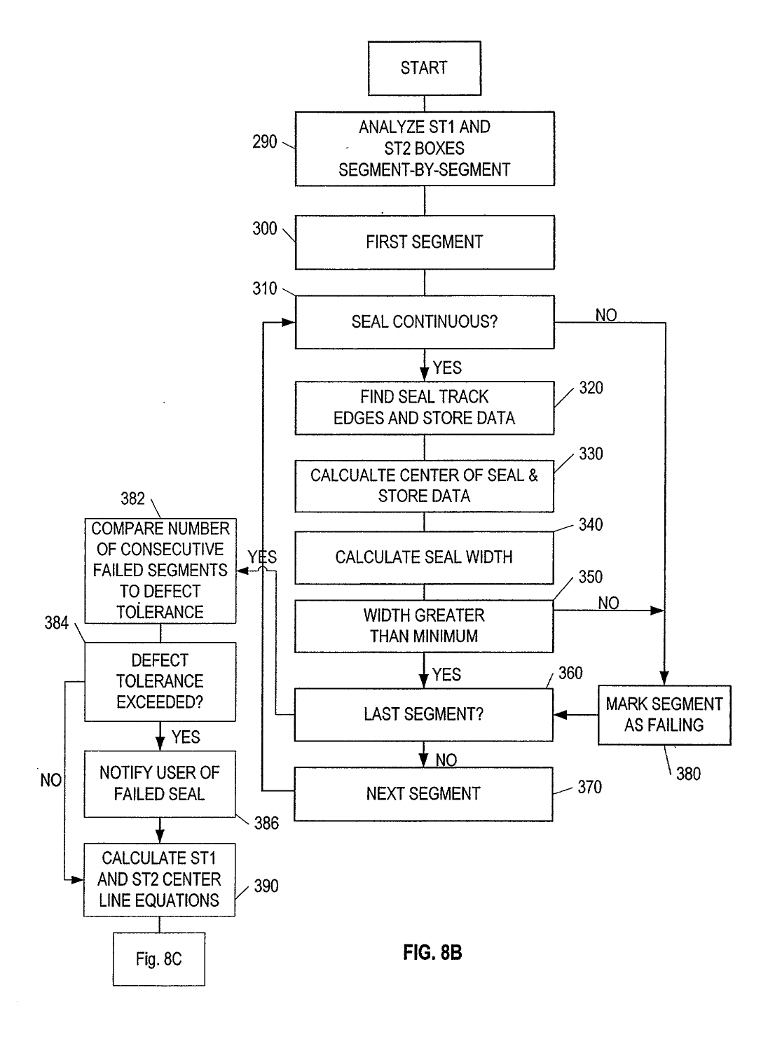

FIG. 7 illustrates an example of a portion of the image captured in one of the ST1 and ST2 boxes 282, 284. In this figure, the segments of the box are illustrated with broken lines, and are identified with letters A-O for the sake of convenience in this written description. The seal track 94 illustrated in FIG. 7 is greatly enlarged to illustrate the non-uniformity that is sometimes encountered in the seal 94 at the micro-level. It should be noted that the STL tool must perform the following steps for each of the two seal boxes 282, 284. Because the steps are identical for the two seal track boxes 282, 284, they are described only once below.

At 300 in FIG. 8B, the STL tool takes in all data from segment A. At 310, the STL tool determines if there are any gaps in the portion of the seal track within segment A. If the seal track is determined to be continuous within segment A, the STL tool goes to 320, where the STL tool finds the seal track edges and stores the data for the position of the seal track edges in segment A. The STL finds the seal track edges by first finding a light-to-dark edge transition corresponding to the top edge of the seal, and then finding a dark-to-light edge transition corresponding to the lower edge of the seal. The allowable range for the grayscale threshold level to detect the edges of the seals 94 is 0 to 255, with the default setting preferably being 30. The machine operator may customize the grayscale threshold level, however.

At 330, the STL tool calculates the center of the portion of the seal 94 within segment A, and stores the data corresponding to the center point. At 340, the STL tool calculates the seal width by comparing the coordinates of the edges of the seal 94 found and stored at 320. At 350, the STL tool determines whether the seal width is greater than a minimum width. The minimum width is a variable that the machine operator may set. If the seal width within segment A is greater than the minimum width, the STL tool advances to 360, where it determines whether the current segment is the last segment of the STL box 282, 284 being analyzed. If it is not the last segment, then the STL tool goes to 370, where it advances to the next segment (e.g., segment B) and starts again at 310 for that segment. Additionally and in some constructions, the tool also determines whether the seal width within segment A is less than a maximum width, which is a variable that the machine operator may set.

If at either 310 or 350 the STL tool returns a “no,” the STL tool skips to 380, where it marks the current segment as failing in the STL tool's memory. After marking the segment as failing, the STL tool continues to 360, where it determines whether the current segment is the last segment of the STL box 282, 284. If the STL tool returns a “yes” at 360, the STL tool has completed analysis of the STL box 282, 284, and moves on to 382.

At 382, the STL tool compares the strings of consecutively-failed segments within the STL boxes 282, 284 to a defect tolerance. The defect tolerance is the maximum number of consecutive segments that may receive failing grades without declaring the seal track 94 defective. The defect tolerance may be set by the machine operator. At 384, the STL tool queries whether the defect tolerance has been exceeded. If the answer is “yes,” then the STL tool generates a fault condition, but if the answer is “no,” then the STL tool moves on to 390. If the STL tool generates a fault condition, the CPU can notify the machine operator at 386 of the defective seal 94 and/or can perform some other action (e.g., perform further processing on the seal) as a result of the fault condition. At 390, the STL tool calculates the center line equations for ST1 and ST2 based on the center point data stored in the STL tool memory for each segment. The CASI software then advances to FIG. 8C.

At 400 in FIG. 8C, the CASI software calculates the distance between the CTE and the CTL by calculating the distance between the robust CTE and CTL equations calculated above at 240 and 270. At 410, this distance is compared to a nominal CTE-to-CTL distance, which may be set by the machine operator. The CASI software then queries at 420 whether the deviation of the CTE-to-CTL distance from the nominal distance is acceptable. The tolerable deviation may be set by the machine operator. If the deviation is not acceptable, the CASI software moves to 430, where it generates a fault condition and notifies the machine operator of an unacceptable deviation. Such a deviation may indicate, for example, that the cover tape 41 is not being properly applied to the carrier tape 34, and that the cover tape dispenser 40 may have to be adjusted.

At 440, the CASI software calculates the distance between the CTE and ST1 by calculating the distance between the robust CTE and STI equations calculated above at 240 and 390. At 450, this distance is compared to a nominal CTE-to-ST1 distance, which may be set by the machine operator. The CASI software then queries at 460 whether the deviation of the CTE-to-ST1 distance from the nominal distance is acceptable. The tolerable deviation may be set by the machine operator. If the deviation is not acceptable, the CASI software moves to 470 where it generates a fault condition and notifies the machine operator of an unacceptable deviation. Such a deviation may indicate, for example, that the cover tape 41 is misaligned with the carrier tape 34, or that there is a problem with the sealing shoe 44.

At 480, the CASI software calculates the distance between the ST1 and ST2 by calculating the distance between the robust ST1 and ST2 equations calculated above at 390. At 490, this distance is compared to a nominal ST1-to-ST2 distance, which may be set by the machine operator. The CASI software then queries at 500 whether the deviation of the ST1-to-ST2 distance from the nominal distance is acceptable. The tolerable deviation may be set by the machine operator. If the deviation is not acceptable, the CASI software moves to 510, where it generates a fault condition and notifies the machine operator of an unacceptable deviation. Such a deviation may indicate, for example, that one of sealing elements of the sealing shoe 44 is wandering away from the other element or that the sealing elements are not parallel to each other.

After the distances between the various parts of the composite tape have been checked as set forth above, the CASI software has completed its analysis of one pitch length of composite tape, and is ready to analyze the next length. The machine advances the composite tape another pitch length, as at 200, and begins the process over for that portion of the composite tape under the CASI module 52.

1. A method for inspecting a composite tape including a cover tape bonded to a carrier tape along first and second seal tracks, the method comprising the steps of:
capturing a digital image of the composite tape;
inspecting the digital image for defects; and
if a defect is found, generating a fault condition.

2. The method of claim 1, wherein said inspecting step includes the steps of:
capturing a portion of the digital image including the first seal track;
dividing the portion of the digital image into a plurality of segments;
inspecting each segment of the seal track digital image; and
assigning a passing or failing grade to each segment.

3. The method of claim 2, wherein said inspecting each segment step includes the step of determining whether the seal is continuous within the segment; and wherein said assigning step includes assigning a failing grade to the segment if the seal is not continuous within the segment.

4. The method of claim 2, wherein said inspecting each segment step includes the step of measuring the width of the seal track within the segment; and wherein said assigning step includes the steps of comparing the width to a minimum width and assigning a failing grade to the segment if the width is below the minimum width.

5. The method of claim 2, wherein said inspecting each segment step includes the steps of determining whether the seal is continuous within the segment and measuring a width of the seal within the segment; and wherein said assigning step includes the step of assigning a failing grade to the segment if the seal is not continuous within the segment or if the width is below the minimum width.

6. The method of claim 2, wherein said inspecting step includes the steps of:
determining a number of consecutively-failed segments for the portion of the digital image; and
comparing the number of consecutively-failed segments to a defect tolerance.

7. The method of claim 1, wherein said step includes the steps of:
finding an edge of the carrier tape within the digital image; and
predicting an area of the digital image where one of the seal tracks is likely to be based on the position of the carrier tape edge.

8. The method of claim 7, wherein said finding step includes using a gradient-based edge tool to find the carrier tape edge within the digital image.

9. The method of claim 7, wherein said inspecting step further includes using a gradient-based edge tool to find seal track edges within the predicted area where one of the seals track is likely to be.

10. The method of claim 1, wherein said inspecting step includes the steps of:
determining robust line equations for the first and second seal tracks;
calculating the distance between the first and second seal tracks based on the equations;
comparing the distance between the seal tracks with an acceptable value; and
assessing whether there is a defect in the seal tracks spacing.

11. The method of claim 1, wherein said inspecting step includes the steps of:
determining a robust equation for an edge of the carrier tape;
determining a robust equation for an edge of the cover tape;
using the equations to determine the distance between the edges;
comparing the distance between the edges with an acceptable value; and
assessing whether there is a defect in the spacing between the edges.

12. The method of claim 1, wherein said inspecting step includes the steps of:
determining a robust equation for an edge of the carrier tape;
determining a robust equation for the first seal track;
using the equations to determine the distance between the carrier tape edge and the first seal track;
comparing the distance between the carrier tape edge and first seal track with an acceptable value; and
determining whether there is a defect in the spacing.

13. The method of claim 1, wherein said inspecting step includes the steps of:
positioning first, second, third, and fourth boxes in the digital image in the nominal positions of a carrier tape edge, a cover tape edge, the first seal track, and the second seal track, respectively;
performing a gradient-based edge tool function on the data within the first, second, third, and fourth boxes to formulate a robust line equation for each of the carrier tape edge, cover tape edge, first seal track, and second seal track;
using the robust line equations to calculate the spacing between the edges of the carrier tape and cover tape;
using the robust line equations to calculate the spacing between the cover tape edge and the seal track;
using the robust line equations to calculate the spacing between the first and second seal tracks; and
comparing the calculated spacings to nominal values; and
assessing whether there are irregularities in the cover tape and seal track positioning.

14. The method of claim 1, wherein said generating step includes the step of notifying an operator of the defect.

15. A packaging and inspection machine for packaging parts in a composite tape and inspecting the composite tape for defects, the composite tape including a cover tape bonded to a carrier tape along first and second seal tracks, the machine comprising:
a camera configured to acquire an image of the composite tape; and
a controller in communication with the camera to receive the acquired image, the controller being configured to
analyze the acquired image for defects in the composite tape, and
generate a fault condition if a defect is detected.

16. The machine of claim 15, further comprising:
a transport configured to deposit parts in compartments of the carrier tape;
a cover tape application and sealing module configured to seal the cover tape to the carrier tape along the first and second seal tracks, thereby capturing the parts within the carrier tape compartments and resulting in the composite tape.

17. The machine of claim 16, wherein the transport is a pick-and-place transport.

18. The machine of claim 15, further comprising an output device in communication with the controller, the output device being configured to generate an output in response to the generation of the fault condition, the output informing an operator of the detected defect.

19. The machine of claim 15, wherein the controller is configured to analyze the acquired image by being further configured to inspect the seal tracks for faults.

20. The machine of claim 19, wherein the controller is configured to inspect the seal tracks by being further configured to
capture a portion of the digital image including the first seal track;
divide the portion of the digital image into a plurality of segments;
inspecting each segment of the seal track digital image; and
assigning a passing or failing grade to each segment.

21. The machine of claim 20, wherein the controller is configured to inspect each segment by being further configured to determine whether the seal is continuous within the segment; and wherein the controller is configured to assign a passing or failing grade by being further configured to assign a failing grade to the segment if the seal is not continuous within the segment.

22. The method of claim 20, wherein the controller is configured to inspect each segment by being further configured to measure a width of the seal track within the segment; and wherein the controller is configured to assign a passing or failing grade by being further configured to compare the width to a minimum width and assign a failing grade to the segment if the width is below the minimum width.

23. The machine of claim 15, wherein the seal tracks have a spacing, and wherein the controller is configured to analyze the acquired image by being further configured to analyze whether there is a defect in the spacing of the seal tracks.

24. The machine of claim 23, wherein the control is configured to analyze whether there is a defect in the spacing of the seal tracks by being further configured to:
determine robust line equations for the first and second seal tracks;
calculate the distance between the first and second seal tracks based on the equations;
compare the distance between the seal tracks with an acceptable value; and
assessing whether there is a defect in the seal tracks spacing.

25. The machine of claim 15, wherein the cover and carrier tapes have an edge, respectively; and wherein the controller is configured to analyze the acquired image by being further configured to analyze whether there is a defect in a spacing between the edges.

26. The machine of claim 25, wherein the control is configured to analyze whether there is a defect in a spacing between the edges by being further configured to
determine a robust equation for the carrier tape edge;
determine a robust equation for the cover tape edge;
use the equations to determine the distance between the carrier tape and cover tape edges;
compare the distance between the edges with an acceptable value; and
assess whether there is a defect in the spacing between the edges.

27. The machine of claim 15, wherein the carrier tape has a tape edge; and wherein the controller is configured to analyze the acquired image by being further configured to analyze whether there is a defect in a spacing between the carrier tape edge and the first seal track.

28. The machine of claim 27, wherein the control is configured to analyze whether there is a defect in a spacing between the carrier tape edge and the first seal track by being further copyrighted to
determine a robust equation for the carrier tape edge;
determine a robust equation for the first seal track;
use the equations to determine the distance between the carrier tape edge and the first seal track;
compare the distance between the carrier tape edge and first seal track with an acceptable value; and
assess whether there is a defect in the spacing.

29. The machine of claim 15, wherein the controller includes a processor and a memory, the memory including one or more software modules executable by the processor to configure the controller.

30. The machine of claim 29, wherein the software modules include a carrier tape edge (CTE) tool that defines a robust equation for an edge of the carrier tape.

31. The machine of claim 30, wherein the CTE tool includes a gradient-based edge tool to locate transitions corresponding to the edge of the carrier tape.

32. The machine of claim 29, wherein the software modules include a cover tape location (CTL) tool that defines a robust equation for an edge of the cover tape.

33. The machine of claim 32, wherein the CTL tool includes a gradient-based edge tool to locate transitions corresponding to the edge of the cover tape.

34. The machine of claim 29, wherein the software modules include a seal track location (STL) tool that defines first and second robust equations for the first and second seal tracks, respectively.

35. The machine of claim 34, wherein the STL tool includes a gradient-based edge tool to locate transitions corresponding to the edges of the seal tracks.

36. The machine of claim 15, wherein the controller includes an application specific integrated circuit.

37. The machine of claim 15, wherein the controller includes discrete circuitry.

38. Software for use with a packaging and inspection machine that inspects a digital image of a composite tape, the machine including a camera operable to acquire the digital image and a processor in communication with camera, the software being executable by the processor to perform the steps of:
receiving the digital image of the composite tape;
analyzing the digital image for defects; and
if a defect is found, generating an output indicating a fault condition.

39. The software of claim 38, wherein said analyzing step includes the steps of:
defining a portion of the digital image including the first seal track;
dividing the portion of the digital image into a plurality of segments;
analyzing each segment of the seal track digital image; and
assigning a passing or failing grade to each segment.

40. The software of claim 38, wherein said analyzing each segment step includes the step of determining whether the seal is continuous within the segment; and wherein said assigning step includes, the step of assigning a failing grade to the segment if the seal is not continuous within the segment.

41. The software of claim 39, wherein said analyzing each segment step includes the step of calculating the width of the seal track within the segment; and wherein said assigning step includes the steps of comparing the width to a minimum width and assigning a failing grade to the segment if the width is below the minimum width.

42. The software of claim 39, wherein said analyzing each segment step includes the steps of determining whether the seal is continuous within the segment and calculating the width of the seal within the segment; and wherein said assigning step includes the step of assigning a failing grade to the segment if the seal is not continuous within the segment or if the width is below the minimum width.

43. The software of claim 39, wherein said analyzing step includes the steps of:
determining a number of consecutively-failed segments for the portion of the digital image; and
comparing the number of consecutively-failed segments to a defect tolerance.

44. The software of claim 38, wherein said inspecting step includes the steps of:
finding an edge of the carrier tape within the digital image; and
defining an area of the digital image where one of the seal tracks is likely to be based on the position of the carrier tape edge.

45. The software of claim 44, wherein said finding step includes using a gradient-based edge tool to find the carrier tape edge within the digital image.

46. The software of claim 44, wherein said inspecting step further includes using a gradient-based edge tool to find seal track edges within the predicted area where one of the seals track is likely to be.

47. The software of claim 38, wherein said analyzing step includes the steps of:
creating robust line equations for the first and second seal tracks;
calculating the distance between the first and second seal tracks based on the equations;
comparing the distance between the seal tracks with an acceptable value; and
determining whether there is a defect in the seal tracks spacing.

48. The software of claim 38, wherein said analyzing step includes the steps of:
calculating a robust equation for an edge of the carrier tape;
calculating a robust equation for an edge of the cover tape;
using the equations to determine the distance between the edges;
comparing the distance between the edges with an acceptable value; and
determining whether there is a defect in the spacing between the edges.

49. The software of claim 38, wherein said analyzing step includes the steps of:
calculating a robust equation for an edge of the carrier tape;
calculating a robust equation for the first seal track;
using the equations to determine the distance between the carrier tape edge and the first seal track;
comparing the distance between the carrier tape edge and first seal track with an acceptable value; and
determining whether there is a defect in the spacing.

50. The software of claim 38, wherein said analyzing step includes the steps of:
positioning first, second, third, and fourth boxes in the digital image in the nominal positions of a carrier tape edge, a cover tape edge, the first seal track, and the second seal track, respectively;
performing a gradient-based edge tool function on the data within the first, second, third, and fourth boxes to formulate a robust line equation for each of the carrier tape edge, cover tape edge, first seal track, and second seal track;
using the robust line equations to calculate the spacing between the edges of the carrier tape and cover tape;
using the robust line equations to calculate the spacing between the cover tape edge and the seal track;
using the robust line equations to calculate the spacing between the first and second seal tracks; and
comparing the calculated spacings to nominal values; and
determining whether there are irregularities in the cover tape and seal track positioning.
